(19) United States
(12) Patent Application Publication
(10) Pub. No.: US 2023/0217550 A1
(43) Pub. Date: Jul. 6, 2023

(54) DEVICE FOR THERMAL LOADING

(71) Applicant: Phoenix Contact GmbH & Co. KG, Blomberg (DE)

(72) Inventors: Frank Best, Bueckeburg (DE); Patrick Hartmann, Blomberg (DE)

(21) Appl. No.: 17/784,113

(22) PCT Filed: Dec. 11, 2020
(86) PCT No.: PCT/EP2020/085801

§ 371 Date: Feb. 13, 2023

(30) Foreign Application Priority Data
Dec. 13, 2019 (BE) BE2019/5901

(51) Int. Cl. H05B 3/26; H05B 1/02

(52) U.S. Cl. CPC H05B 3/26; H05B 1/0294; H05B 2203/007

(57) ABSTRACT

A device for thermally loading an enclosure and/or a heat sink includes: at least one circuit board arranged or arrangeable in the enclosure or on the heat sink, each at least one circuit board having at least one conductor track and at least two fields within each of which a continuous electrically conductive track section of the at least one conductor track runs, a path length of the at least one conductor track section within each of the at least two fields being greater than one or each edge length of a respective field or one or each diagonal of the respective field or a perimeter of the respective field. The fields include tiles of a tiling of a first side of the circuit board The conductor track sections each thermally load the enclosure and/or the heat sink depending on a current feed to the respective conductor track.

### CROSS-REFERENCE TO PRIOR APPLICATIONS

This application is a U.S. National Phase application under 35 U.S.C. § 371 of International Application No. PCT/EP2020/085801, filed on Dec. 11, 2020, and claims benefit to Belgian Patent Application No. BE 2019/5901, filed on Dec. 13, 2019. The International Application was published in German on Jun. 17, 2021 as WO/2021/116431 under PCT Article 21(2).

### FIELD

The invention relates to a device for thermally loading an enclosure or a heat sink.

### BACKGROUND

Electronic housings, for example those from Phoenix Contact, are often designated by a characteristic value for the power loss Pₗₒₛₛ [W], i.e. a value in watts, which indicates the thermal load that the housing is capable of bearing as an example of an enclosure. This indicates the potential for the dissipation of the heat generated from electronic power loss.

For example, the permissible dissipation loss may be indicated for different electronic housings in terms of shape, size, and material, depending on the installation situation and the ambient temperature in each case. For example, a mounting rail housing with a width of 35 mm may bear a power loss of 7.9 W as permissible dissipation loss in an assembled installation situation, whereas the same housing may bear a power loss of 16.3 W with a lateral spacing or clearance of at least 20 mm.

Conventionally, in order to determine the permissible power loss, a heat source, such as an electrical resistor, is operated in the housing to be tested instead of the electronics actually intended for the housing. However, the measurement of the housing temperature as a function of the power loss and the ambient temperature depends on a large number of undefined measurement parameters. These undefined measurement parameters include size, geometry, position and electrical component behaviour of the heat source. Thus, the measuring system is undefined. In particular, results of a measurement in different measurement set-ups or different housings are not comparable and are not reproducible.

Such a problem exists when measuring heat sinks. Heat sinks have a thermal resistance (or a thermal conductivity, respectively) as a thermal characteristic value. This characteristic value is also not comparable and not reproducible with different measurement set-ups or different sizes of the heat sink.

### SUMMARY

In an embodiment, the present invention provides a device for thermally loading an enclosure and/or a heat sink, comprising: at least one circuit board arranged or arrangeable in the enclosure or on the heat sink, each at least one circuit board comprising at least one conductor track and at least two fields within each of which a continuous electrically conductive track section of the at least one conductor track runs, a path length of the at least one conductor track section within each of the at least two fields being greater than one or each edge length of a respective field or one or each diagonal of the respective field or a perimeter of the respective field, wherein the fields comprise tiles of a tiling of a first side of the circuit board, and wherein the conductor track sections are each configured to thermally load the enclosure and/or the heat sink depending on a current feed to the respective conductor track.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic representation of a device for thermal loading of an enclosure or heat sink according to a first exemplary embodiment in a front view;

FIG. 2 shows a schematic representation of the device for thermal loading of an enclosure or heat sink according to a first exemplary embodiment in a rear view;

FIG. 3 shows a schematic representation of a field of the device according to a first exemplary embodiment in a first perspective view;

FIG. 4 shows a schematic representation of the field of the device according to the first exemplary embodiment in a second perspective view;

FIG. 5 shows a schematic representation of the device for thermal loading of an enclosure or heat sink according to a second exemplary embodiment in a front view;

FIG. 6 shows a schematic representation of the device for thermal loading of an enclosure or heat sink according to a second exemplary embodiment in a front view;

FIG. 7 shows a schematic representation of the device for thermal loading of an enclosure or heat sink according to a first variant of the first exemplary embodiment in a front view;

FIG. 8 shows a schematic representation of the device for thermal loading of a housing as an example of the enclosure according to a second variant of the first exemplary embodiment;

FIG. 9 shows a schematic representation of the device for thermal loading according to a third variant of the first exemplary embodiment in a front view; and

FIG. 10 shows a schematic representation of the device for thermal loading according to a fourth variant of the first exemplary embodiment In a front view.

### DETAILED DESCRIPTION

In an embodiment, the present invention provides a device for the thermal loading of an enclosure or a heat sink, which makes it possible to reproducibly determine a thermal characteristic value, which in turn makes it possible to compare different enclosures or heat sinks.

According to one aspect, a device is provided for thermally loading an enclosure (or housing) and/or a heat sink. The device comprises at least one circuit board, which is or may be arranged in the enclosure or on the heat sink. Each of the at least one circuit board comprises at least one conductor track. Each of the at least one circuit board also comprises at least two fields, within which a continuous electrically conductive conductor track section of the at least one conductor track runs, wherein a path length of the conductor track section within each of the at least two fields is greater than one or each edge length of the respective field or one or each diagonal of the respective field or a perimeter of the respective field. The conductor track sections are configured to thermally load the enclosure and/or the heat sink depending on a current feed (or current supply) to the respective conductor track in each case.

While the circuit board arranged in the enclosure, for example, in a housing or on the heat sink, comprises several fields, exemplary embodiments of the device may thermally load the enclosure or the heat sink at individual points distributed inhomogeneously or evenly, for example depending on the current feed to the respective conductor track.

The thermal load may be spatially determined by the location of the fields. Alternatively, or additionally, the thermal load due to the current feed may be controlled, for example depending on time and/or on a temperature in the enclosure and/or an ambient temperature outside the enclosure or the heat sink.

Exemplary embodiments of the device may be a tool for determining the thermal load capacity of the enclosure, primarily of a characteristic value for the power loss, and/or for determining the transfer of waste heat from the enclosure or for determining a thermal conductivity or a thermal resistance of the heat sink as thermal characteristic value. The thermal load capacity of the enclosure or heat sink may be the thermal output emitted by the device as a function of an ambient temperature, for example the maximum thermal output at which the enclosure or heat sink does not exceed a maximum temperature, or which is reached in the stationary state.

The fields and/or the conductor track sections arranged therein may be uniform. Uniformity allows the thermal characteristics determined by means of exemplary embodiments of the device to be determined on the same basis, and/or compared with each other, for example within a housing family of different housings and/or beyond. For example, different sizes and/or shapes of the housing or heat sink, respectively, may be thermally loaded in a comparable and/or reproducible manner by a number or arrangements, respectively, of the uniform fields and/or conductor track sections corresponding to the respective size and/or shape. Uniformity may help

exemplary embodiments to achieve a comparability of thermal loading (for example, with different sizes or shapes of enclosure or of the heat sink, respectively) and/or a reproducibility of the experimental set-up.

The circuit board may also be referred to as a printed circuit board.

Each conductor track section may be an ohmic conductor. According to the current feed, each conductor track section as an ohmic conductor may emit a power loss as thermal output for thermal loading. Preferably, the conductor track sections and/or the at least one conductor track do not comprise any capacitances and/or any inductances.

Within the circuit board, the conductor track section of each of the at least two fields of the at least one circuit board may be connected electrically conductive to the conductor track section of at least one field adjacent to the respective field of the same circuit board. The conductor track section of each of the at least two fields of the at least one circuit board may be in direct electrical contact with the conductor track section of at least one field adjacent to the respective field of the same circuit board, for example via a joint edge of the adjacent fields.

The conductor track sections belonging to the same conductor track of the at least one conductor track and/or the conductor track sections connected electrically conductive to each other within the circuit board may be connected in series and/or form the respective conductor track.

The conductor track or the conductor track sections that are connected electrically conductive to each other may form an ohmic conductor.

The at least one circuit board may comprise several conductor tracks.

One or each of the at least one circuit board may have a first side and a second side opposite the first side. The first side may comprise the at least two conductor tracks. The first side may have a predetermined breaking line running between the conductor tracks (e.g., parallel to the conductor tracks) and/or without crossing the conductor tracks. Alternatively, or additionally, the second side may comprise predetermined breaking lines (or breakaway lines) that run transverse (e.g., perpendicular) to one or each of the at least two conductor tracks on the first side.

The predetermined breaking line or each of the predetermined breaking lines may correspond to a line on the circuit board, along which a thickness of material of the circuit board (for example, a distance between the first side and the second side) is less than elsewhere on the circuit board, i.e. less than within the fields.

The fields may be arranged in rows and columns on the respective circuit board. Each row or column may comprise one of the conductor tracks. Preferably, either each row or each column comprises one of the conductor tracks. The rows may also be referred to as “lines”.

The device may also comprise at least one electrically conductive connection, preferably a wiring or bridging, between ends of different conductor tracks on the same circuit board, for example between ends of different conductor tracks on the same circuit board or on the same circuit board on adjacent conductor tracks.

Adjacent rows may each comprise a conductor track which is connected electrically conductive at a first end to the conductor track of a first adjacent row and is connected electrically conductive at a second end opposite the first end to the conductor track of a second adjacent row. For example, the conductor tracks of two or more adjacent rows may be connected in series in a meandering pattern.

The circuit board may comprise (for example as printed circuit board panels) a (preferably crossing-free) continuous conductor track (for example on the first side). The continuous conductor track may optionally be cut (for example as a result of cutting the edge). The remaining several conductor tracks may be wired together (preferably at the connection points).

The different conductor tracks on the same circuit board may be connected in series and/or in parallel via the electrically conductive connection, preferably in a circuit network.

Directly adjacent conductor track sections (for example, directly adjacent fields) and/or directly adjacent conductor tracks (for example, directly adjacent rows) may be connected electrically conductive. Alternatively, or additionally, conductor track sections at a distance from each other (for example, two conductor track sections with at least one further field arranged in between) and/or conductor tracks located at a distance from each other (for example, two conductor tracks with at least one further row arranged in between) may be connected electrically conductive.

Preferably, all conductor tracks are connected, for example, directly or indirectly, electrically conductive to a circuit network (for example an overall circuit and/or an ohmic resistor network). The device and/or the at least one circuit board may comprise a (preferably two-pole) power connector for all conductor tracks and/or for supplying current to all conductor track sections.

The electrical connections of the different conductor tracks may correspond to different currents or current feeds (for example, different amperages and/or different power outputs or power densities, for example, power output per unit area of the circuit board) of interconnected conductor tracks (or rows, respectively) and/or interconnected conductor track sections (or fields, respectively). As a result, the circuit board may have areas with different power output (also: power loss) and/or different power density (also: different thermal ranges) resulting from the respective current feed.

The circuit network may determine an unequal current feed through the individual conductor track sections, preferably a relationship of different current values (also: amperages) through the respective conductor track sections and/or an inhomogeneous power loss or power density of different conductor track sections.

The device may comprise at least two of the circuit boards. The device may also comprise at least one electrically conductive connection, preferably wiring, between conductor tracks on different circuit boards. The conductor tracks on the different circuit boards may be connected in series and/or in parallel via the electrically conductive connection, for example in the circuit network. The at least one electrically conductive connection may electrically conductively connect two ends of the conductor track sections or the conductor tracks that are unconnected within the circuit board.

The conductor tracks that are connected electrically conductive to each other may form an ohmic conductor. The circuit network may be an ohmic resistor network.

The fields may be surrounded on all sides in each case (or the fields may be limited on each side or a perimeter of each of the fields may be limited). Alternatively, or additionally, the fields may be polygons (preferably regular polygons), hexagons, rectangles, squares or triangles in each case. Alternatively, or additionally, the fields may be unit cells of a periodic grid on the circuit board in each case. Alternatively, or additionally, the fields may have edges that are aligned parallel to each other in each case.

The fields may be tiles of a tiling (or tessellation) of a first side of the circuit board (for example, up to an edge of the circuit board). The tiling may be a Platonic tiling or demi-regular tiling or Archimedean tiling.

The edge lengths of edges that are parallel to each other of different fields may be commensurable.

The fields may be of uniform size or parameterised or scaled (preferably integer) by means of a basic measurement (for example, a least common multiple of the edge length). For example, edge lengths of edges that are parallel to each other of different fields are multiples of the basic dimension. As a result of a uniform basic dimension (preferably for the entire circuit board), different enclosures and/or different heat sinks may be comparable with regard to their thermal load capacity and/or their transfer of waste heat.

The fields may be a polygon (preferably a regular polygon), a rectangular area or a square in each case. The fields may each have the same shape, for example the same, except for a (preferably isotropic) scaling of the size.

The fields may be rectangular areas. Line shapes of different fields of the device (for example, the same circuit board or different circuit boards) may be rotated 90°, 180° or 270° towards each other.

Each conductor track section may be branch-free and/or crossing-free within the respective field (for example rectangular area) and/or may run through a layer of the circuit board. For example, the conductor track section within the respective field and/or each conductor track within the respective circuit board may be fabricated in an individual copper layer.

The at least two fields may cover the respective circuit board (preferably substantially) on one or two sides. The at least two fields may cover or substantially cover the respective circuit board at least on one side, in that the fields are adjacent to each other on the respective side and/or an edge region of the circuit board, which does not comprise any fields, between the fields and an edge of the circuit board is narrower than an edge length of the fields.

The device may also comprise a power source. The power source may be configured to supply current to the at least one conductor track.

Preferably, no active or non-linear electronic components are installed on or connected to (for example to the conductor tracks) the at least one circuit board or in the at least one conductor track.

One or each of the at least one circuit board may each have a first side and a second side opposite the first side. The first side may comprise the at least two fields. The second side may be in contact with or brought into contact with the enclosure or the heat sink.

The device may also comprise a temperature sensor configured to detect a temperature of the enclosure or heat sink and/or an ambient temperature. Alternatively, or additionally, the device may also comprise a control unit or regulating unit (also: controller or regulator, or control system or regulating system), which is configured to control the current feed of the at least one conductor track depending on a temperature detected by the temperature sensor (for example the temperature of the enclosure or the heat sink and/or the ambient temperature). The control may be configured to store power consumption (also: power loss) of the current feed as a function of the temperature detected (for example, the ambient temperature).

The fields (or their conductor track sections, respectively) may be arranged in rows and columns (for example as a matrix) on the respective circuit board. A number of fields in at least two (for example directly adjacent) columns and/or at least two (for example directly adjacent) rows may be different from each other.

Alternatively, or additionally, the fields within a row may be equally spaced or have a uniform width. Alternatively, or additionally, the fields within a column may be equally spaced or have a uniform width. Alternatively, or additionally, the fields within a row may have the same spacing or uniform width as the fields within a column.

Preferably, the fields (for example, each side of a circuit board) are free of overlap.

At least one of the fields may be arranged outside the rows and columns, preferably in an edge region of the circuit board.

Individual or all fields may be mounted (for example, bonded or glued) onto a carrier. The carrier may correspond to a real circuit board (also: pattern), for example with regard to its contour or shape. The device may be configured to thermally load an enclosure or heat sink of the real circuit board.

The circuit board may have (for example, as a printed circuit board panel for depaneling) a basic shape (preferably independent of the enclosure or heat sink), such as a rectangle or a square.

Alternatively, or additionally, the circuit board may be formed (for example, taking the printed circuit board panel as a starting point) by milling, breaking out (for example, along the predetermined breaking lines), sawing (for example, cut-off grinding) and/or cutting (for example, laser cutting or water jet cutting), for example, on the basis of the selected housing. The circuit board may be shaped according to the specifications of the real circuit board.

Each conductor track section may comprise two connection points (or terminals), preferably contact areas and/or solder points, on opposite edges of the respective rectangular area.

The circuit board may be formed by milling, breaking out, sawing and/or cutting between two fields (for example between two adjacent printed circuit board panels). A connection point remaining at the edge of the circuit board (e.g., at the breaking edge) may be used for contacting (preferably supplying current to) the respective conductor track. Alternatively, or additionally, the circuit board may be formed by milling, breaking out, sawing and/or cutting within the edge of at least one field (for example, the printed circuit board panel). The at least one incomplete field remaining at the edge of the circuit board (e.g., at the breaking edge) or a conductor track section interrupted therein may remain unused or unpowered during thermal loading.

A line shape (also: shape) of the conductor track sections in the at least two fields may correspond (or agree or match). Corresponding line shapes may comprise a geometric similarity of the conductor track sections, i.e., the line shapes may be congruent and/or scaled.

The fields may have different sizes. A line shape of the conductor track sections in the respective fields may be scaled according to the size of the respective field (for example, the respective rectangular area).

The fields may be bordered (or delimited) by predetermined breaking lines (preferably for isolating the respective circuit board). The circuit board may be a printed circuit board panel and/or may be individually created from a printed circuit board panel, for example by breaking off excess fields or fields protruding beyond a cross-section of the enclosure or an abutment of the heat sink.

The fields may be arranged in rows and columns on a first side of the at least one circuit board. The first side of the respective circuit board may have crossing-free predetermined breaking lines along the edges of the fields in the direction of the rows preferably not in the direction of the column. A second side of the respective circuit board opposite the first side may have predetermined breaking lines along the edges of the fields (on the first side) in the direction of the rows and/or the columns. The predetermined breaking lines on the second page may cross (for example in accordance with the edges of the fields on the first page) in the direction of the rows and the columns.

A line shape (also: shape) of each conductor track section within the respective field (for example, within the respective rectangular area) may be in a meandering pattern.

The at least one circuit board may comprise at least one field within which a thermoelectric transducer, preferably a Peltier element, is arranged to generate a temperature gradient. The temperature gradient may be parallel to the circuit board. For example, the Peltier element may be arranged to drive a heat transfer within the circuit board. Alternatively, or additionally, the temperature gradient may be perpendicular to the circuit board. For example, the Peltier element may be arranged to drive a heat transfer to its surroundings. By transferring heat to its surroundings while consuming power, the Peltier element may act as a cooling element. The at least one field may be referred to as a cooling point.

The enclosure may be a housing, a casing or a control cabinet.

The device may also comprise the enclosure and/or the heat sink. A contour of the circuit board may correspond to an inside contour of the housing, a cross-section of the housing or a heat contact surface of the heat sink.

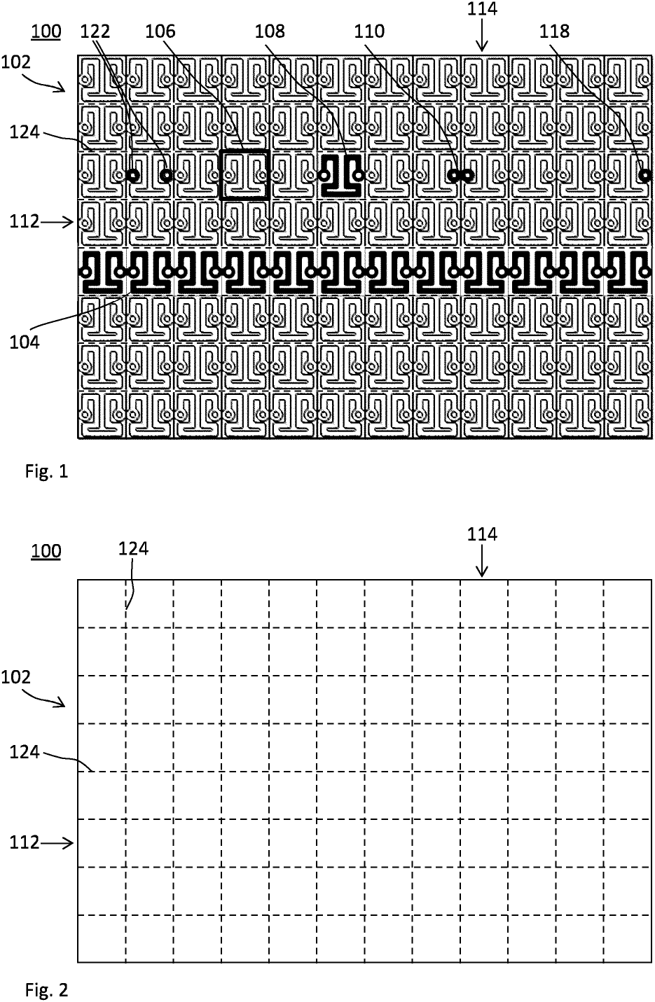

FIG. 1 shows an exemplary embodiment of a device, generally indicated with the reference numeral 100, for the thermal loading of an enclosure and/or a heat sink. The device comprises at least one circuit board 102 that is or may be arranged in the housing or heat sink, each comprising at least one conductor track 104, and each comprising at least two fields 106, within each of which is running a continuous electrically conductive conductor track section 108 of the at least one conductor track 104. A path length of the conductor track section 108 within each of the at least two fields 106 is greater than one or each edge length of the respective field 106, or one or each diagonal of the respective field 106, or a perimeter of the respective field 106. The conductor track sections 108 are each configured to thermally load the enclosure and/or the heat sink depending on a current feed to the respective conductor track 104.

Exemplary embodiments of the device 100 may thermally load the enclosure (for example, a housing) or the heat sink, preferably using a measured or controlled current feed and/or a measured or controlled power loss. The power loss generated by the device 100 may form the basis for the thermal classification of the enclosure or heat sink, i.e., the determination of the thermal index.

For example, the thermal index corresponds to the power loss necessary to reach a certain temperature (for example, a predetermined maximum temperature) of the enclosure or heat sink, preferably at a certain ambient temperature and/or installation situation.

The thermal index may form a basis for decision-making or a selection criterion when selecting a housing (which is as compact as possible, for example) for a given electronic circuit and/or in a conceptual design phase or for electronics development of the circuit.

The features highlighted in black in FIG. 1 serve the purpose of clarification of the designation using reference numerals. The features highlighted in black may be structurally identical to the corresponding features shown with a thin line or border.

Each conductor track section 108 is part of a conductor track 104. Each conductor track section 108 has a respective connection point 122, for example a terminal pad or solder pad, at opposite ends of the respective conductor track section 108. Where the connection point 122 is within the circuit board 102,an electrically conductive connection 110 to the adjacent conductor track section 108 exists as part of the same conductor track 104. If the connection point 122 is at the edge of the circuit board 102, this is an end 118 of the respective conductor track 104 and/or is configured to connect an electrically conductive connection to an additional conductor track 104.

In the first exemplary embodiment shown in FIG. 1, the fields 106 are rectangles, preferably arranged in rows 112 (also: lines) and columns 114. The number of fields 106, number of rows 112 and/or number of columns 114 shown is only exemplary.

The conductor track section 108 arranged in each field 106 is longer than a perimeter of the field 106, for example in a meandering pattern within the area of the respective field 106. Due to the length, the conductor track section 108 covers the respective field 106 evenly for a homogeneous heat transfer to the area. Furthermore, the ohmic resistance R of the conductor track section 108 increases with the length for the same conductor track thickness and/or the same conductor track width and/or the same conductor track material, which forms the basis of the power loss Ploss = R · I2 (i.e., the power of the heat transfer) in the field 106 when there is a current feed I to the respective conductor track section 108.

The circuit board 102 may also be referred to in technical terms as a “printed circuit board” or PCB. The fields 106 may also be referred to as segments. Since the conductor track sections 108 have an ohmic resistance R, the circuit board 102 may also be referred to as an R-PCB segment matrix. The fields 106 are local heat sources arranged in rows 112 and columns 114.

A (for example, two-dimensional and/or geometric) shape of the conductor track sections 108 and/or a size of the conductor track sections 108 may be uniform throughout the circuit board 102 and/or for all fields 106, as exemplified by the rectangular arrangement of the fields 106 in the first exemplary embodiment. In this way, the device 100 may thermally load the housing, reproducibly and independently of the location and/or manufacturer thereof, in order to determine the thermal index as a comparative value. Optionally, the same shape may be scaled to different sizes in different sized fields 106 accordingly. For example, the edge lengths of the different sized fields 106 are an integral multiple of a basic measurement (also: lowest common denominator). The circuit board 102 may or may not comprise fields 106 with an edge length equal to the basic measurement.

The circuit board 102 is scored (also: simply cut) crossing-free as predetermined breaking lines 124 on the side on which the conductor track (104) is arranged or applied (also: first side, front side or upper side). On the other side (also: second side, rear side or lower side), the circuit board 102 has cross scores as predetermined breaking lines 124. FIG. 2 shows a schematic representation of the second side of the first exemplary embodiment. The predetermined breaking lines 124 enable the circuit board 102 to be isolated, preferably with the granularity of the fields 106. By only providing cross scores on the second side, the connection 110 is possible within the circuit board 102 without restricting the isolation of the circuit board 102.

Each connection 122 at each end 118 of each conductor track 104 is configured to contact and preferably mechanically connect an electrical conductor, such as a pole of a power connection (also referred to as an in or out connection, respectively) or a bridge connection to another conductor track 104 (for example, on the same circuit board 102 or on another circuit board 102). The connection 122 may comprise a hole and/or a contact or solder pad.

The connection between different conductor tracks 104 is generally designated by reference numeral 116. Examples of the connections 116 are shown in a schematic representation in FIGS. 6 to 10. The power connection is generally designated by reference numeral 120. Examples of the power connection 120 are shown in a schematic representation in FIGS. 6 to 10.

Preferably, the columns 114 and/or rows 112 are labelled on a scored field edge of the circuit board 102, for example each numbered consecutively.

The arrangement, preferably extending in a linear direction, of the conductor track sections 104 belonging to the same conductor track 104 may also be referred to as an axis (or, in the first exemplary embodiment, as a line 112). In that the conductor track 104 is through-coated at the connections 110 between its conductor track sections 108, electrical bridges at these connections 122 within the circuit board 102 may be omitted.

The fields 106 are preferably square and/or n-fold rotationally symmetrical, whereby n is an integer greater than or equal to 3 (for example, 4-fold rotationally symmetrical). The n-fold rotational symmetry is advantageous in the arrangement (i.e., placement) of at least one circuit board 102 in the enclosure or on the heat sink. For example, two or more circuit boards 102 with conductor track sections 108 rotated 360°/n (and/or 2·360°/n, and/or ..., and/or (n-1)·360°/n) towards each other (i.e., conductor track sections 108 rotated with respect to the shape of the conductor track section 108) may be arranged relative to each other, for example via the connections 116, and/or arranged in the enclosure or on the heat sink.

Exemplary embodiments of the device 100 may be fine-linked, scalable, variable, homogeneous, divisible, and/or distributable (for example, with respect to the arrangement of the fields 106 and thus the heat sources) on the basis of the fields 106 and the predetermined breaking lines 124 that run along the perimeter of the fields (for example, on the first side and/or the second side).

Exemplary embodiments of the device 100 may be flat and thus have a low convective resistance.

Each field 106 and/or each conductor track section 108 may be configured to generate heat (for example, waste heat from the electrical power supply line) during the current feed, preferably using each conductor track section (108) as an ohmic resistor (for example, made of copper and/or in a meandering pattern) and/or using at least one component (for example, an electrical resistor).

The exemplary embodiments of the device 100 may be applicable as a heat source for the determination of thermal indices. Preferably, a power loss (for example, Ploss [W]) and/or a waste heat conductivity (for example, Ploss per temperature gradient [W/K]) may be determined as a thermal index using the device 100, for example, the thermal index for a housing as enclosure.

Alternatively, or additionally, a thermal resistance Rth [K/W] may be determined as a thermal index. The thermal resistance may be determined as an index for an electronics housing, a heat sink, a combination of electronics housing and at least one heat sink, a control box and/or a control cabinet (as examples of an enclosure and/or a heat sink) using the device.

Each exemplary embodiment of the device 100 may comprise a control unit (or for short: control) and at least one temperature sensor. For example, a first temperature sensor detects the temperature of the enclosure or heat sink. A second temperature sensor may detect the ambient temperature outside the enclosure or heat sink. The control may be configured to control a current at the power connection 120 as a function of the detected temperature of the enclosure or heat sink, preferably to achieve (for example, in a stationary state) a target temperature for the enclosure or heat sink (for example, a target temperature of 100° C.). The target temperature may be the maximum temperature of the enclosure or the heat sink.

Alternatively, or additionally, each exemplary embodiment of the device 100 may comprise a determination unit. The determination unit may be configured to determine the power loss required to achieve the target temperature as a function of the ambient temperature. The power loss as a characteristic value may be determined in a temperature range of the ambient temperature, for example between 20° C. and 100° C. or between a standardised room temperature and the target temperature of the enclosure, at which the power loss is zero, by definition. Alternatively, or additionally, a (for example negative) slope of the power loss as a function of the ambient temperature may be determined using equalisation calculations (for example using linear regression). The slope (preferably without the negative sign) may correspond to the thermal characteristic value.

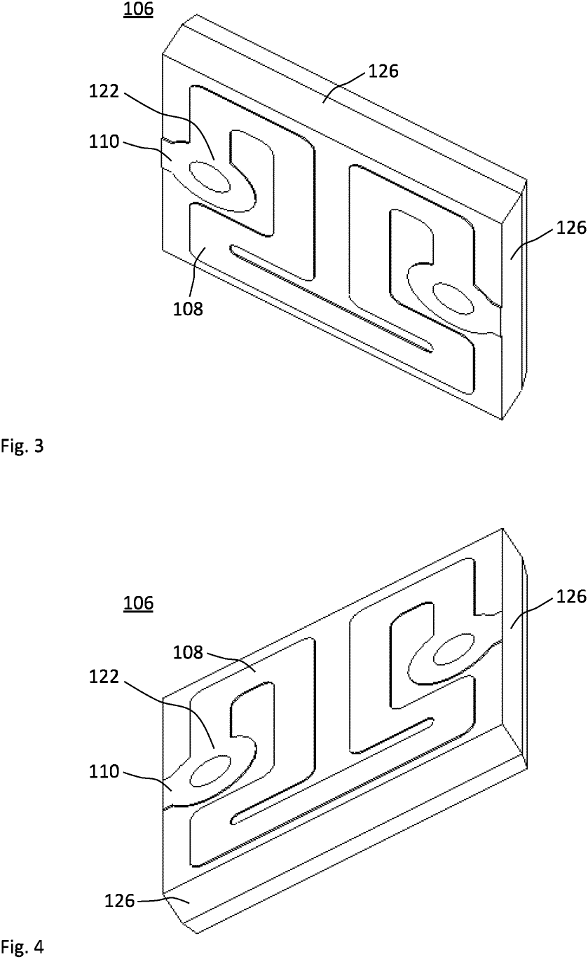

FIGS. 3 and 4 show an exemplary embodiment of one of the fields 106 of the device 100, for example according to the first exemplary embodiment. Reference numerals which correspond with other exemplary embodiments or other figures may designate interchangeable or corresponding features.

The field 106 shown in FIGS. 3 and 4 may have been created by breaking out along the predetermined breaking lines 124 from the at least one circuit board 102 of the device 100 as field. Alternatively, the field 106 in the device 100 may be or be able to be supplied with current as a single circuit board 102, for example as a hotspot 134, via connections 116.

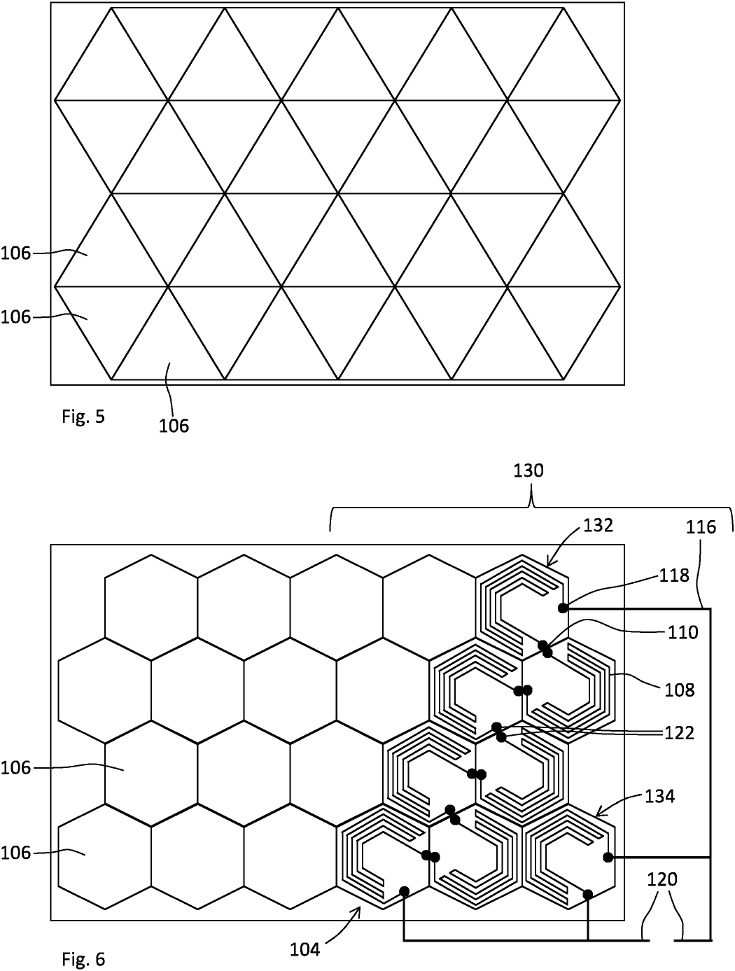

FIG. 5 shows an arrangement of the fields 106 according to a second exemplary embodiment. The fields 106 are triangles. A tiling of the circuit board 102 into the fields 106 is platonic or regular.

FIG. 6 shows an arrangement of the fields 106 according to a third exemplary embodiment. The fields 106 are hexagons. The tiling of the circuit board 102 is platonic or regular.

The axis, along which the conductor track elements 106 on the same track 104 are arranged, may run diagonally across the circuit board.

Furthermore, the third exemplary embodiment shows a circuit network 130, which may be implemented accordingly in any exemplary embodiment, in which a proportion of the total amperage of the power connection 120 flowing through a conductor track section 108 to form a hot spot 134 is greater than the proportion of the total amperage flowing through the warm spots 132 of the other conductor track sections 108. Preferably, the warm spots 132 and hot spots 134 are connected parallel to each other, whereby the number of conductor track sections 108 as warm spots 132 (and thus a resistance of the corresponding conductor track 104) is greater than the number of conductor track sections 108 as hot spot or hot spots 134.

The power loss (from the point of view of heat transfer) may also be referred to as heat output.

The conductor track section 108 may be an example of a heating element 108. Optionally, at least one of the fields 106 comprises a cooling element, for example, instead of the heating elements 108. In other words, the heating element of at least one field 106 may generate negative waste heat. Optionally, at least one of the fields 106 comprises (for example, instead of a heating element or heat source) a negative heat source, i.e., a heat sink. For example, at least in individual fields 106, the disclosure of a heat source may be realised by a heat sink. Similarly, “waste heat” may comprise negative “waste heat”. For example, the generation of waste heat may be realised by a dissipation of heat (preferably from the housing) or a (for example partial) transfer of heat into another form of energy (for example into energy with a lower entropy than the heat or into athermal electromagnetic radiation, light or electrical power, preferably using the Seebeck effect).

Each exemplary embodiment may additionally comprise areas of the circuit board 102 in which at least one heating element 108 as a hot spot 134 is supplied with current differently (preferably with a stronger current) compared to the at least one additional heating element 108 as a warm spot 132, in order to achieve a different (preferably greater) heat output. It is thus possible to simulate hot spots 134 (also: hotspots) for the circuit to be used, i.e., to replicate them in real life using the device 100.

Furthermore, the heat output of the heating elements 108 may be controlled using the control. For example, the heat output may be time-dependent, preferably to create thermostress. This allows temperature gradients or associated mechanical stresses in the housing or heat sink to be tested.

Optionally, at least one of the fields 106 comprises a cooling element, for example, instead of the heating elements 108. The cooling element or the cooling elements may be arranged on the circuit board 102 and/or connected to the mains. The cooling element or each of the cooling elements may comprise, for example, a Peltier element.

Furthermore, any exemplary embodiment of the device 100 may be configured to thermally load an electronics housing with a heat sink. For example, one or more circuit boards 102 of the device 100 may be arranged parallel to each other in the housing. The heat sinks may be arranged on one or both ends of the circuit boards 102 (for example, on an edge of the parallel circuit boards 102). The heat sinks may comprise slats on an outer surface facing away from the circuit board or boards 102. The heat sink(s) may extend perpendicular to a plane of the circuit boards 102.

The device 100 may be present as a matrix (i.e., with the fields 106 in rows and columns). A shape or intended shape (technically also referred to as a “PCB outline”) adapted for the enclosure (for example, the housing) or the heat sink may be broken out of this matrix by means of the predetermined breaking lines 124. The resulting embodiment may, specifically and/or in the largest possible connection or number of fields (106) (also: segment connection), fit and/or be arranged in a cross-section of the respective housing. Optionally, several circuit boards (which are preferably each broken out of a matrix or each formed by breaking out) may be electrically bridged in series (for example using bridges 116). Thereafter, the thermal index can be determined.

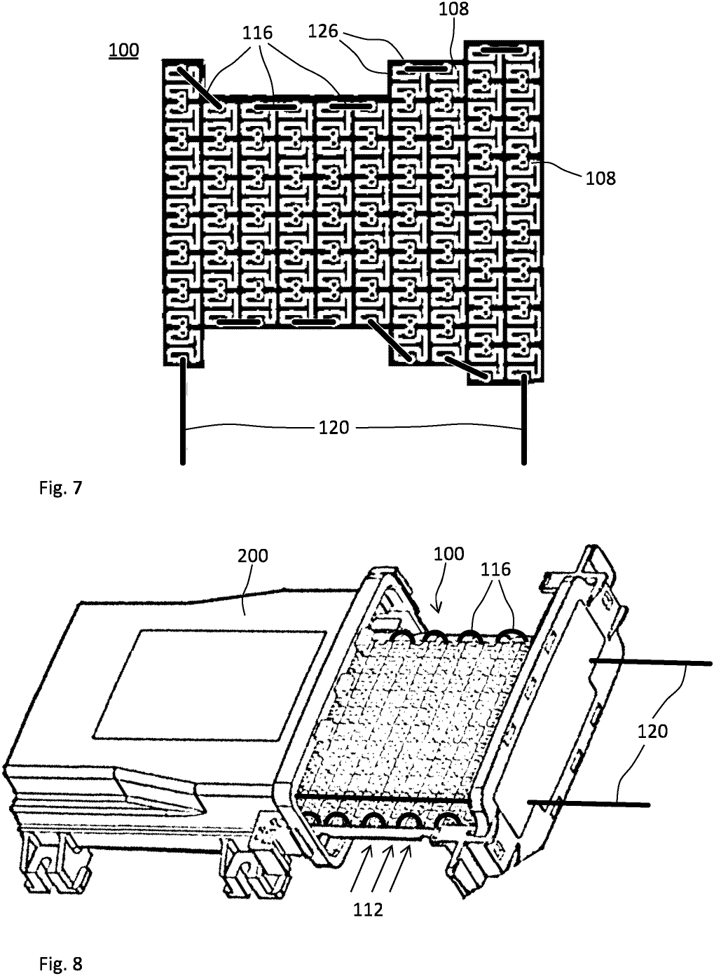

FIGS. 7 to 10 show variants of the first exemplary embodiment, each bridged and/or formed by breaking out individual rows 112, individual columns 114 and/or individual (fields) 106). Preferably, fields 106 are only broken out until the circuit board 102 fits into the housing, i.e. completely fills the cross-section to the maximum or with the granularity of the fields 106.

FIGS. 7 and 8 show first and second variants of the first exemplary embodiment of the device 100. The device 100 for thermally loading a housing 200 is or may be arranged as an example of the enclosure in the housing 200.

The power connection 120 may be accessed from outside the housing 200, for example supplied by the control.

Each exemplary embodiment of the device is preferably configured to determine the thermal characteristic value (also referred to in technical language as benchmark) of a heat sink. The thermal characteristic value may examine the suitability of the heat sink 300 for the application purpose (i.e., a heat load corresponding to the circuit).

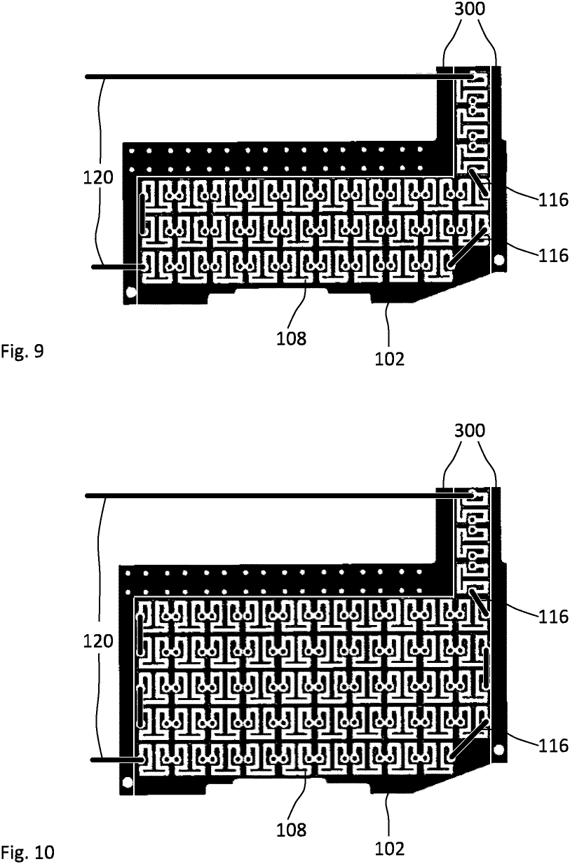

FIGS. 9 and 10 show variants of the first exemplary embodiment, which, together with the second side, are in contact with or may be brought into contact with a heat sink 300 for heat transfer.

In variants of any exemplary embodiment of the device 100, the first side may be in contact with or may be brought into contact with a heat sink 300 for heat transfer. As a result, the thermal conductivity of the system of device 100 and heat sink may be improved.

For example, a heat-conducting material (also referred to in technical language as “Thermal Interface Material” or TIM, for example a heat-conducting paste) is arranged between the first side and the heat sink 300, preferably over the entire surface, for heat transfer between the conductor track sections 108 and the first side and/or for substance-to-substance bonding between the first side and the heat sink 300.

The heat-conducting material may be electrically insulating. The heat-conducting material may spatially separate the conductor tracks 104, preferably the conductor track sections 108 and/or the connection points 122 and/or the conductive connections 110 between adjacent conductor track sections 108 of the first side, from the heat sink.

In each exemplary embodiment, the conductor tracks 104, preferably the conductor track sections 108 and/or the connection points 122 and/or the conductive connections 110 between adjacent conductor track sections 108, may be electrically insulated on the surface of the first side and/or coated with an electrically insulating material (for example, a protective coating) and/or arranged (preferably in a sandwich design) within the circuit board 102.

By breaking out along the predetermined breaking lines 124, the different size variants may be formed using uniform fields 106 and/or conductor track sections 108 (preferably with respect to edge length of the fields 106 and/or shape of the conductor track sections 108). The size is thereby adapted to the heat sink 300 to be thermally loaded.

The principle of uniformity of the shape of the conductor track section (108) for the determination of comparable thermal characteristic values may also be applied to housings of different sizes.

The circuit board 102 is equipped with conductor track sections 108 as heating elements, which are electrically connected to each other (reference numeral 110). The fields 106 and/or the connection 110 may be arranged in rows and/or columns.

In a first approach, in each exemplary embodiment, there may be an electrical connection 116 at the end of each row 112 to the next row 112 such that the last heating element 108 of one row 112 is connected to the first heating element 108 of the next row.

In a second approach, in each exemplary embodiment, the connections 110 and/or the connection 116 may comprise conductor bridges (for short: bridges) or be realised by them. One or each of the conductor bridges may be set by a cable and/or provided in the respective circuit board 102 of the device 100 (for example, in a printed circuit board panel). Optionally, each field 106 may comprise more than 2 connections 110 which may be cut selectively and/or as required.

Furthermore, the first approach and the second approach may be combined in a device 100. For example, the first approach and the second approach may be implemented for different connections 110 and/or different connections 116.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of Reference Numerals

| | |
|---|---|
| Device | 100 |
| Circuit board | 102 |
| Conductor track | 104 |
| Field | 106 |
| Conductor track section, preferably heating element | 108 |
| Conductive connection between conductor track sections | 110 |
| Row of fields | 112 |
| Column of fields | 114 |
| Conductive connection between conductor tracks, preferably bridges | 116 |
| End of the conductor track | 118 |
| Power connection or power source | 120 |
| Connection point | 122 |
| Predetermined breaking line (or breakaway lines) | 124 |
| Breaking edge | 126 |
| Circuit network | 130 |
| Warm spot | 132 |
| Hot spot or hotspot | 134 |
| Enclosure | 200 |
| Heat sink | 300 |

1. A device for thermally loading an enclosure and/or a heat sink, comprising:
at least one circuit board arranged or arrangeable in the enclosure or on the heat sink, each at least one circuit board comprising at least one conductor track and at least two fields within each of which a continuous electrically conductive track section of the at least one conductor track runs, a path length of the at least one conductor track section within each of the at least two fields being greater than one or each edge length of a respective field or one or each diagonal of the respective field or a perimeter of the respective field,
wherein the fields comprise tiles of a tiling of a first side of the circuit board, and
wherein the conductor track sections are each configured to thermally load the enclosure and/or the heat sink depending on a current feed to the respective conductor track.

2. The device of claim 1, wherein each conductor track section comprises an ohmic conductor.

3. The device of claim 1, wherein the conductor track section of each of the at least two fields of the at least one circuit board is connected electrically conductively to the conductor track section of at least one field of a same circuit board within the circuit board adjacent to the respective field.

4. The device of claim 1, wherein the conductor track sections belonging to a same conductor track of the at least one conductor track and/or the conductor track sections connected electrically conductively to each other within the circuit board are connected in series and/or form the respective conductor track.

5. The device of claim 1, wherein the at least one circuit board comprises several conductor tracks.

6. The device of claim 5, wherein the fields are arranged in rows and columns on the respective circuit board, and each row or each column comprises one of the conductor tracks.

7. The device of claim 5, further comprising:
at least one electrically conductive connection between ends of different conductor tracks on the same circuit board.

8. The device of claim 7, wherein the-different conductor tracks of the same circuit board are connected in series and/or in parallel via the at least one electrically conductive connection in a circuit network.

9. The device of claim 8, wherein the circuit network determines is configured to determine an unequal current feed through the individual conductor track sections.

10. The device of claim 7, wherein the at least one electrically conductive connection connects two respective unconnected ends of the conductor track sections or of the conductor tracks within the circuit board.

11. The device of claim 1, wherein the fields:
are surrounded on all sides in each case; and/or
are polygons; and/or
are unit cells of a periodic grid on the circuit board; and/or have edges that are aligned parallel to each other.

12. The device of claim 1, wherein the fields comprise Plantonic tiling or demi-regular tiling or Archimedean tiling.

13. The device of claim 1, wherein edge lengths of edges that are parallel to each other of different fields are commensurable.

14. The device of claim 1, wherein the fields are rectangular areas and a line shape of different fields is rotated 90°, 180°, or 270° towards each other.

15. The device of claim 1, wherein each conductor track section within a respective rectangular area is branch-free and/or crossing-free and/or runs through a layer of the circuit board.

16. The device of claim 1, further comprising:
a power source configured to supply current to the at least one conductor track.

17. The device of claim 1, wherein one or each of the at least one circuit board in each case comprises a first side and a second side opposite the first side,
wherein the first side comprises the at least two fields, and
wherein the second side is in contact with or is configured for contact with the enclosure or the heat sink.

18. The device of claim 1, further comprising:
a temperature sensor configured to detect a temperature of the enclosure or the heat sink; and
a control unit configured to control the current feed to at least one conductor track as a function of a temperature detected by the temperature sensor.

19. The device of claim 1, wherein the fields are arranged in rows and columns on the respective circuit board.

20. The device of claim 1, wherein each conductor track section comprises two respective connection points at opposite edges of a respective rectangular area.

21. The device of claim 1, wherein a line shape of the conductor track sections in all or at least two fields is equal.

22. The device of claim 1, wherein the fields have different sizes and a line shape of the conductor track sections in a respective fields is scaled to a size of a respective rectangular area.

23. The device of claim 1, wherein the fields are bordered by breakaway lines of a respective circuit board.

24. The device of claim 1, wherein the fields are arranged in rows and columns on a first side of the at least one circuit board, and the first side of a respective circuit board has crossing-free breakaway lines along edges of the fields in a direction of the rows, and
wherein a second side of the respective circuit board opposite the first side has crossing predetermined breaking lines along the edges of the fields on the first side in a direction of the rows and/or the columns.

25. The device of claim 1, wherein a line shape of each conductor track section within the respective field comprises in a meandering pattern.

26. The device of claim 1, wherein the at least one circuit board comprises at least one field within which a thermoelectric transducer is arranged and configured to generate a temperature gradient.

27. The device of claim 26, wherein the temperature gradient is parallel to the circuit board and is configured to transfer heat within the circuit board, or
wherein the temperature gradient is perpendicular to the circuit board and is configured to transfer heat to surroundings.

28. The device of claim 1, wherein the housing comprises a housing, a casing, or a control cabinet.

29. The device of claim 1, further comprising:
the enclosure or the heat sink,
wherein a contour of the circuit board corresponds to an inner contour of the enclosure, a cross-section of the enclosure, or a heat contact area of the heat sink.
